(19) United States
(12) Patent Application Publication
(10) Pub. No.: US 2016/0113449 A1
(43) Pub. Date: Apr. 28, 2016

(54) Towel and Washcloth Holding Device

(71) Applicant: Nathaniel Gainey, Graham, NC (US)

(72) Inventor: Nathaniel Gainey, Graham, NC (US)

(21) Appl. No.: 14/862,271

(22) Filed: Sep. 23, 2015

Related U.S. Application Data
(60) Provisional application No. 62/067,540, filed on Oct. 23, 2014.

(51) Int. Cl. A47K 10/04; F16M 13/02

(52) U.S. Cl. CPC A47K 10/04; F16M 13/02

(57) ABSTRACT

A towel holding device for storing a towel and a washcloth in a rolled configuration. The holding device includes a bracket having a first section rigidly affixed to a second section, wherein the first and second sections are preferably perpendicular to one another. The bracket includes a first ring thereon, wherein the first ring includes an open central area sized to receive a rolled towel therein. The bracket further includes a second ring, wherein the second ring includes an open central area sized to receive a rolled washcloth therein. Thus, the first ring preferably comprises a larger diameter than the second ring. Further, the first and second rings are positioned adjacent to one another on the bracket. The bracket can be affixed to a support surface, such as a wall, using any conventional fasteners, such as screws, or nails, among others.

### CROSS REFERENCE TO RELATED APPLICATION

This application claims the benefit of U.S. Provisional Application No. 62/067,540 filed on Oct. 23, 2014. The above identified patent application is herein incorporated by reference in its entirety to provide continuity of disclosure.

### BACKGROUND OF THE INVENTION

### Field of the Invention

The present invention relates to holding devices for towels, washcloths, and other similar articles. More specifically, the present invention provides a holding device adapted for use in holding a towel and a washcloth, wherein the holding device comprises a bracket having a first ring for use in holding a towel and a second ring for use in holding a washcloth.

Towels and washcloths can be difficult to store in a neat and organized manner. Towels are often folded and stacked on top of one another so that they do not consume much space while being stored. However, stacking the towels may make it difficult to retrieve a towel from the stack, and there is risk that a person may knock over the stack of towels. Further, when a user prepares to take a bath or shower, the user needs a washcloth in addition to a towel. However, washcloths are generally stored separately from the towels, and there may not be enough washcloths for each towel. Thus, a device that facilitates storage of a towel and washcloth is desired.

Devices have been disclosed in the prior art that relate to towel and washcloth holding devices. These include devices that have been patented and published in patent application publications. These devices generally relate to towel and washcloth holding devices having a plurality of shelf members used to support towels and washcloths, such as U.S. Pat. No. 2,839,202, U.S. Pat. No. 2,990,066, U.S. Design Pat. No. D194,528, U.S. Pat. No. 4,875,592, and U.S. Pat. No. 771,905.

These prior art devices have several known drawbacks. While the devices in the prior art provide means for storing towels and/or washcloths, the prior art fails to disclose a device comprising a bracket that can be mounted to a support surface, wherein the bracket includes rings of different diameters thereon, wherein each ring is adapted to hold a towel or washcloth in a rolled configuration. Thus, the prior art devices do not allow a user to easily store a towel and washcloth together in an organized manner.

In light of the devices disclosed in the prior art, it is submitted that the present invention substantially diverges in design elements from the prior art and consequently it is clear that there is a need in the art for an improvement to existing towel holding devices. In this regard the instant invention substantially fulfills these needs.

### SUMMARY OF THE INVENTION

In view of the foregoing disadvantages inherent in the known types of holding devices now present in the prior art, the present invention provides a new holding device for towels and washcloths wherein the same can be utilized for providing convenience for the user when storing a towel and washcloth in an organized and convenient manner.

It is therefore an object of the present invention to provide a new and improved holding device for towels and washcloths comprising an L-shaped bracket having a first ring for use in holding a towel and a second ring for use in holding a washcloth.

It is another object of the present invention to provide a holding device for towels and washcloths that can be mounted to a support surface, such as a wall or a door.

Another object of the present invention is to provide a holding device for towels and washcloths that is adapted to hold a towel and a washcloth in a rolled configuration for easy access.

Another object of the present invention is to provide a holding device for towels and washcloths that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the holding device.

FIG. 2 shows a side view of an embodiment of the holding device.

FIG. 3 shows a perspective view of an embodiment of the holding device in use.

FIG. 4 shows a perspective view of an alternate embodiment of the holding device.

FIG. 5 shows a side view of an alternate embodiment of the holding device.

### DETAILED DESCRIPTION OF THE INVENTION

Reference is made herein to the attached drawings. Like reference numerals are used throughout the drawings to depict like or similar elements of the holding device of the present invention. For the purposes of presenting a brief and clear description of the present invention, the preferred embodiment will be discussed as used for holding a towel and a washcloth in a rolled configuration for storage thereof. The figures are intended for representative purposes only and should not be considered to be limiting in any respect.

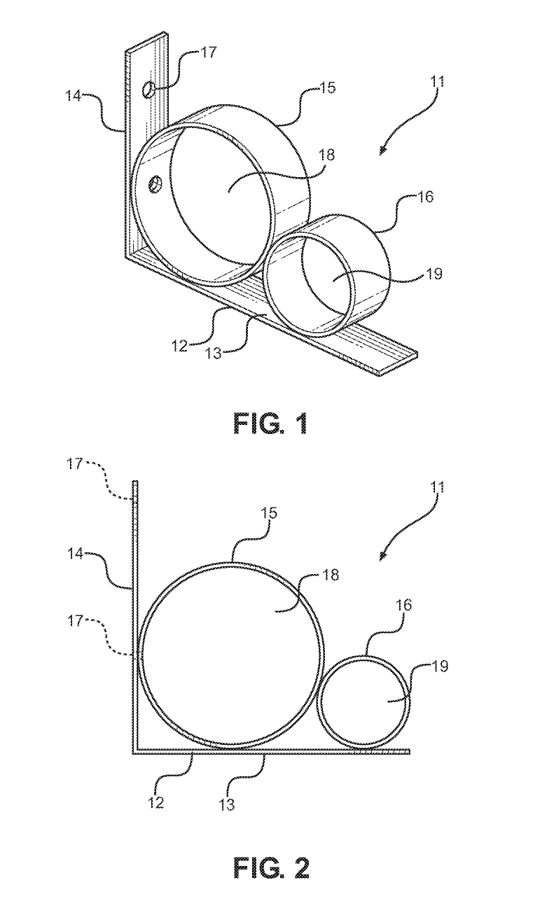

Referring now to FIGS. 1 and 2, there are shown perspective and side views of an embodiment of the holding device, respectively. The holding device 11 comprises a bracket 12 having a first section 13 permanently affixed to a second section 14 so as to form an L-shape. Preferably, the first section 13 is positioned perpendicularly to the second section 14. The bracket 12 includes one or more apertures 17 therethrough, wherein the apertures 17 are adapted to receive a fastener in order to secure the bracket 12 to a support surface, such as a wall or door, among others. The bracket 12 is adapted to be secured to a support surface using any suitable fasteners, such as screws or nails.

The holding device 11 further comprises a first ring 15 thereon, wherein the first ring 15 is adapted to hold a towel in a rolled configuration. The ring 15 is positioned on the bracket 12 and is rigidly affixed to both of the first section 13 and second section 14 thereof. A second ring 16 is also affixed to the bracket 12 and is adapted for use in holding a washcloth in a rolled configuration. The second ring 16 is affixed to the first section 13 as well as to a portion of the first ring 15. In this way, the bracket 12, first ring 15, and second ring 16 are securely attached to one another so that the holding device 11 is stable and durable. The first and second rings 15, 16 are shown as being composed of a rolled sheet or panel, however in alternate embodiments the first and second rings 15, 16 are alternately composed of wire or other tubular material. Further, the first and second rings 15, 16 are affixed to the bracket 12 and to one another using any suitable fastening method, such as by means of welding or adhesives, among others.

The first ring 15 is preferably larger in diameter than said second ring 16 so that said first ring 15 defines a larger central area 18 than the central area 19 defined by the second ring 16. In this way, the first ring 15 is suited for holding a towel, whereas the second ring 16 is suited for holding a washcloth. In alternate embodiments, the second ring 16 is larger in diameter than the first ring 15.

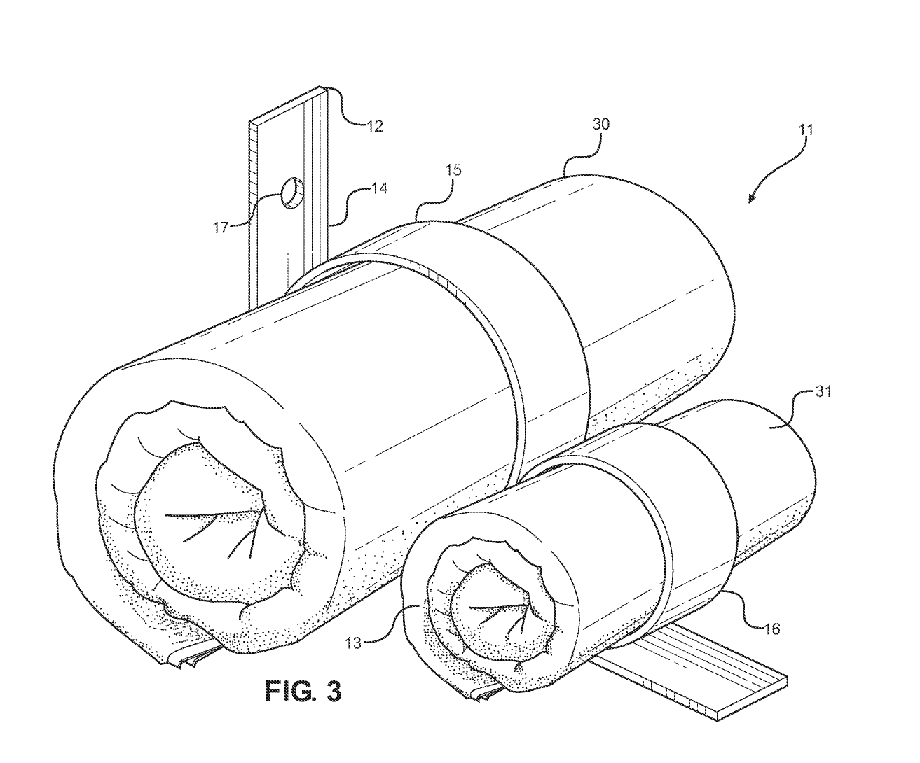

Referring now to FIG. 3, there is shown a perspective view of an embodiment of the holding device in use. In operation, the bracket 12 can be mounted to a support surface, such as a wall, by inserting fasteners through the apertures 17 thereon. The user can then position a rolled towel into the open central area of the first ring 15, wherein the ring 15 holds the towel in position. The user can further insert a washcloth into the open central area of the second ring 16. The towel and washcloth are held adjacent to one another for easy access thereto. In this way, a washcloth and towel are stored together in a compact configuration.

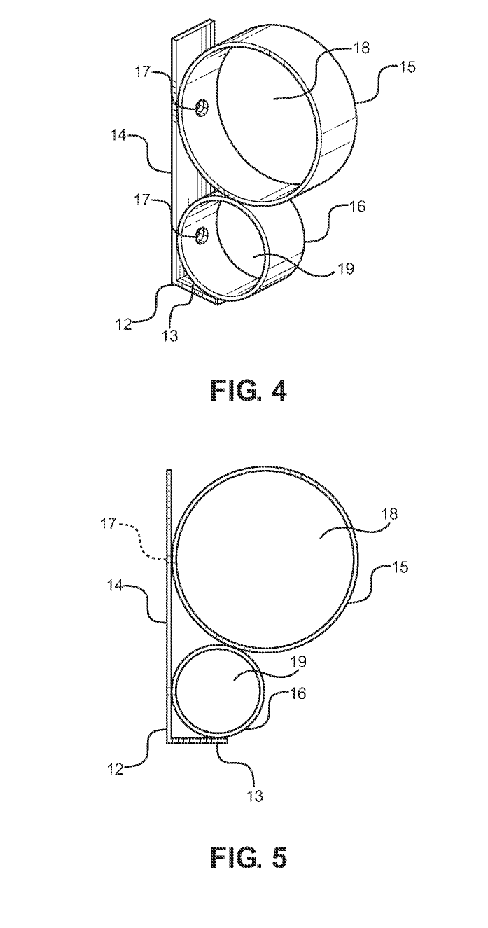

Referring now to FIGS. 4 and 5, there are shown perspective and side views of an alternate embodiment of the holding device of the present invention. The illustrated embodiment provides a holding device 11 wherein the first and second rings 15, 16 are arranged in alternate positions. The illustrated embodiment comprises a bracket 12 having a first section 13 and a second section 14. Preferably, the first and second sections 13, 14 are perpendicular to one another. A second ring 16 is affixed to the bracket 12 and contacts both the first and second section 13, 14 thereof. A first ring 15 is positioned on the second section 14 of the bracket 12 and contacts the second ring 16. Thus, in the illustrated embodiment, the first and second rings 15, 16 are disposed in a vertical, stacked orientation. In this way, a towel can be stored in a rolled configuration within the open central area 18 of the first ring 15 of the holding device 11, and a washcloth can be stored within the open central area 18 of the second ring 16. The washcloth is positioned beneath the towel when stored on the holding device 11.

The bracket 12 comprises one or more apertures 17 thereon through which one or more fasteners can be positioned so as to affix the holding device 11 to a support surface, such as a wall. In the illustrated embodiment, the apertures 17 are positioned on the second section 14 of the bracket 12 so that the second section 14 can be positioned flush against a support surface and affixed thereto.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A holding device for towels and washcloths, comprising:
a bracket having a first section and a second section;
a first ring having an open central area, wherein said first ring is affixed to said bracket;
a second ring having an open central area, wherein said second ring is affixed to said bracket.

2) The holding device for towels and washcloths of claim 1, wherein said first ring is affixed to said first section and said second section of said bracket, and wherein said second ring is affixed to said first section of said bracket.

3) The holding device of claim 1, wherein said first section is perpendicular to said second section.

4) The holding device of claim 1, wherein said bracket includes one or more apertures adapted to receive fasteners therethrough so as to secure said bracket to a support surface.

5) The holding device of claim 1, wherein said first ring and said second ring are substantially circular in configuration.

6) The holding device of claim 1, wherein said first ring comprises a larger diameter than said second ring.

7) The holding device of claim 1, wherein said first ring and said second ring are arranged in a linear configuration.
